(19) United States
(12) Patent Application Publication
(10) Pub. No.: US 2002/0065734 A1
(43) Pub. Date: May 30, 2002

(54) Method of processing purchase information applied to a business information processing platform

(76) Inventor: Tien-Fu Kuo, Taipei Hsien (TW)

Correspondence Address: BACON & THOMAS, PLLC, 625 Slaters Lane, 4th Floor, Alexandria, VA, 22314-1176, US

(21) Appl. No.: 09/808,057

(22) Filed: Mar. 15, 2001

(30) Foreign Application Priority Data
Nov. 30, 2000 (TW) 89125527

(51) Int. Cl. G06F 19/00; G06F 17/60

(52) U.S. Cl. 705/26; 700/106

(57) ABSTRACT

A business information processing has a processor, a storage device, and a memory. The storage device stores a plurality of executable software programs and related information to build up a required material list database, a supplier database, a serial number index database, a price enquiring list database, and an order list database. The software programs include: a required material list establishing means for establishing a required material list for the buyer and storing the required material list in the required material list database; a price enquiry list generating means for matching serial number information provided by a buyer with serial number information provided by a supplier and establishing a price enquiry list and to store the price enquiry list in the price enquiring list database; a price quotation list generating means for processing the price enquiry list to generate a price quotation list; and an order list generating means for processing the price quotation list to generate an order list.

### BACKGROUND OF THE INVENTION

1. Field of the Invention

The present invention relates to a networked business environment and, more particularly, to providing a business information processing platform to act on behalf of a buyer to purchase goods or services.

2. Description of the Related Art

Currently, purchasing in the arena of business to business (B2B) electronic commerce is carried out by a business platform. Some of the business platforms are managed by powerful buyers. These buyers place request information on their business platforms, and suppliers use this request information when marketing on the business platform.

Other business platforms, so-called agent business platforms, are managed by intermediary companies, which bring together transactions between a plurality of buyers and a plurality of suppliers. However, for agent business platforms, the buying party generally must spend a lot of time selecting a supplier, or to bargain with the supplier over the price. Furthermore, a single buyer needs to adapt to different suppliers, and the supplier must also adapt to different buyers. Therefore, the overall effort required of suppliers and buyers on agent business platforms is almost equal to the effort expended in more traditional business modes. Additionally, the buyer cannot unite with other buyers to negotiate for a better price.

### SUMMARY OF THE INVENTION

The main objective of the present invention is to provide a business information processing platform to act on behalf of the buyer for procurements. The buyer needs only to deal with the procurement procedure between the business information processing platform and the plurality of suppliers. Similarly, the suppliers only need to deal with the selling procedure between the business information processing platform and the plurality of buyers.

Another main objective of the present invention is to collect together a plurality buyers to negotiate a better price with a supplier.

The secondary objective of the present invention is to quickly and automatically provide a price enquiring list and a price quotation list, since the merchandise provided by the suppliers is stored in a supplier database on the business information processing platform.

To achieve these objectives, the business information processing platform of the present invention includes basic computer basic structure, such as a processor, a storage device, and a memory. In order to achieve a business information processing platform that has a high degree of efficiency and automation, the storage device stores a plurality of executable software programs and related information to build up a required material list database, a supplier database, a serial number index database, a price enquiring list database, and an order list database.

The software programs include:

a required material list establishing means for establishing a required material list for the buyer and storing the required material list in the required material list database;

a price enquiry list generating means for matching the serial number information provided by the buyer with the serial number information provided by the supplier and combining at least a portion of the information stored in the required material list database with a portion of the information stored in the supplier database via the serial number index database to establish a price enquiry list and to store the price enquiry list in the price enquiring list database;

a price quotation list generating means for processing the price enquiry list to generate a price quotation list, the price quotation list containing the serial number information from the buyer, article name and specification information, quantity and price quotation information; and

an order list generating means for processing the price quotation list to generate an order list.

Other objectives, advantages, and novel features of the invention will become more apparent from the following detailed description when taken in conjunction with the accompanying drawings.

### BRIEF DESCRIPTION OF THE DRAWINGS

FIG. 1 is a hardware structure diagram of the business information processing platform of the present invention.

FIG. 2 is a flowchart of the business information processing platform of the present invention.

FIG. 3 shows an embodiment of the required material list database of the present invention.

FIG. 4 shows an embodiment of the price enquiring list database of the present invention.

FIG. 5 shows an embodiment of the price quotation list database of the present invention.

FIG. 6 shows an embodiment of the order list database of the present invention.

FIG. 7 shows an embodiment of the serial number index database of the present invention.

FIG. 8 shows an embodiment of the supplier database of the present invention.

### DETAILED DESCRIPTION OF THE PREFERRED EMBODIMENT

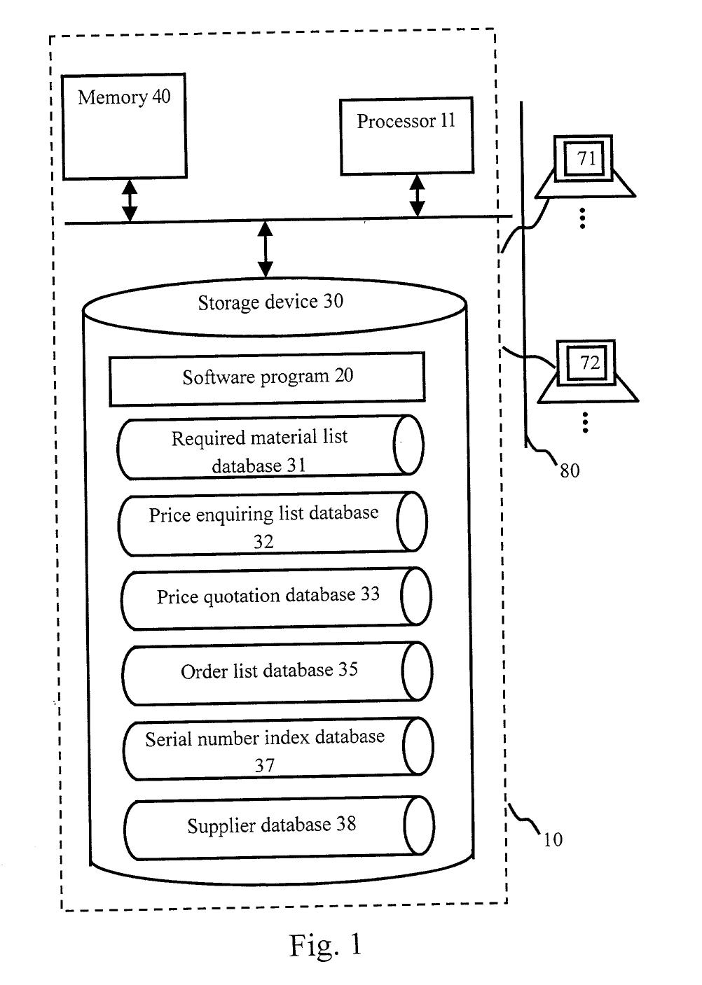

Please refer to FIG. 1. FIG. 1 is a hardware structure diagram of the business information processing platform 10 of the present invention. The business information processing platform 10 uses a common computer structure, which has a processor 11, a storage device 30 (for example, hard discs) and a memory 40 (such as RAM). The business information processing platform 10 is applied to a networked environment, such as the Internet 80. The business information processing platform 10 provides merchandise, such as electronic parts for communication devices, for a buyer 71 to order, and transforms the order from the buyer 71 for a supplier 72. The business information processing platform 10 of the present invention is not just a traditional B2B business platform or an agent business platform. The business information processing platform 10 should be taken as a purchase service provider for the buyer 71, and a website service provider for the supplier 72.

In order to give the business information processing platform 10 a high degree of efficiency and automation, the storage device has a plurality of software programs 20 and a plurality of databases. In a preferred embodiment of the present invention, the storage device 30 stores a required material list database 31, a price enquiring list database 32, a price quotation database 33, an order list database 35, a serial number index database 37, and a supplier database 38. During execution, the software programs 20 should be stored in the memory 40 for execution by the processor 11. The following description of the process steps of the present invention will explain the means built up in the software programs 20.

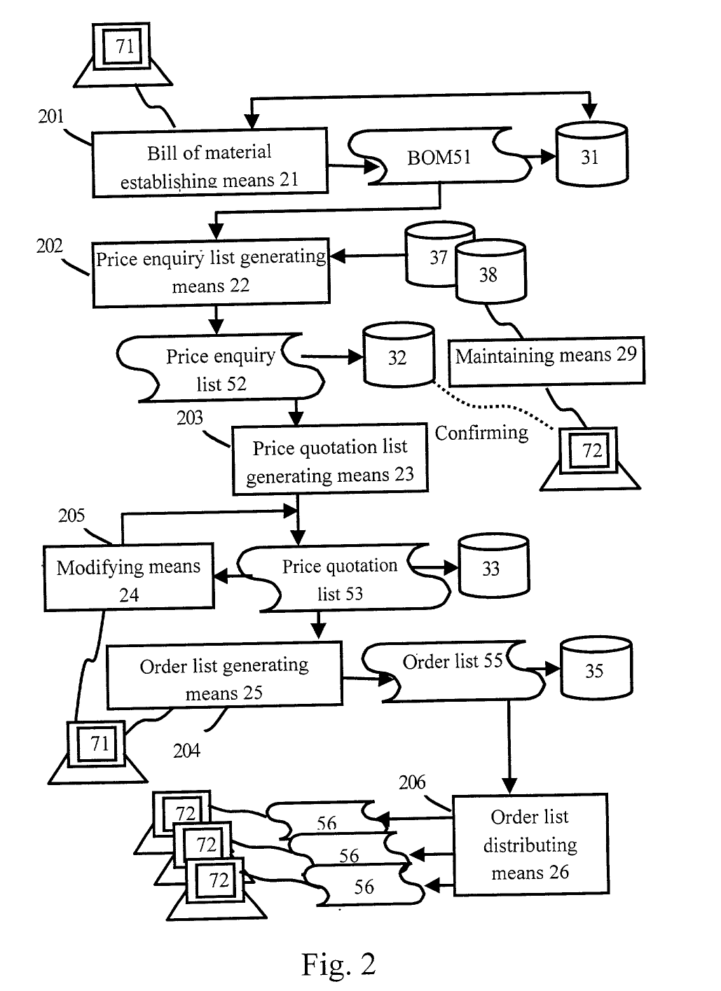

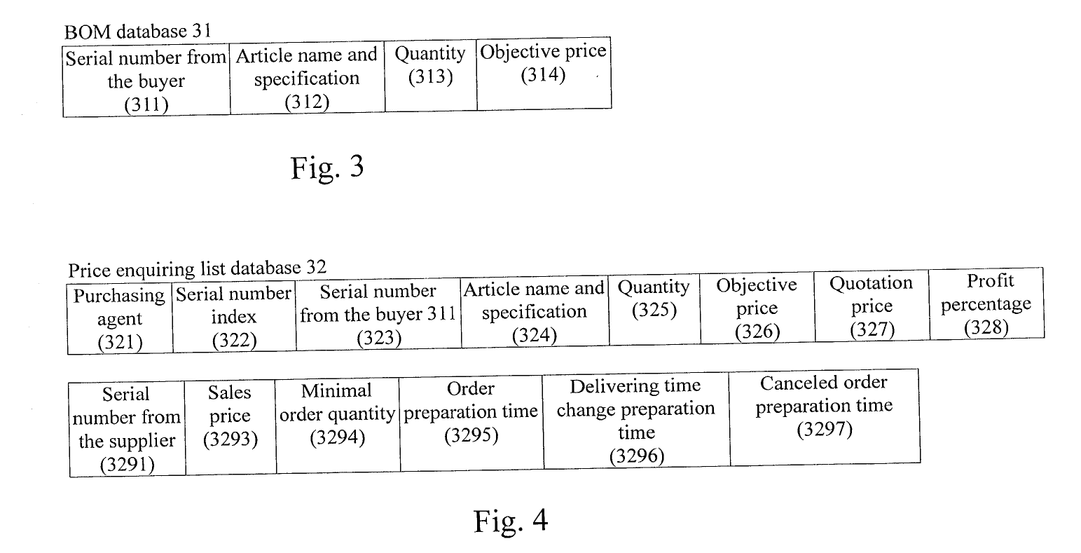

Please refer to FIG. 2. FIG. 2 is a flowchart of the business information processing platform of the present invention. Please also refer to FIG. 3 to FIG. 8.

Step 201

The buyer 71 establishes a required material list 51. The required material list 51 contains related information about merchandise ordered by the buyer 71. The buyer 71 may utilize the required material list establishing means 21 to find a stored required material list 51 from the required material list database 31 and modify it to create a new required material list 51. In another words, the required material list database 31 stores all required material lists established by the buyer 71. Therefore, the buyer 71 builds up his or her own required material list database in the business information processing platform 10.

Another method entails the buyer 71 using his or her computer to establish the required material list 51′, and then sending the required material list 51 to the business information processing platform 10. The required material list establishing means 21 transforms the required material list 51′ into the required material list 51 in a standard format provided by the business information processing platform 10 and stores it into the required material list database. This method is especially necessary to add a new buyer 71.

Please refer to FIG. 3. FIG. 3 shows an embodiment of the required material list database 31 of the present invention. In the preferred embodiment, the required material list database 31 comprises a plurality of columns: serial number information from the buyer 311, article name and specification information 312, and quantity information 313, and a desired price 314 (the price desired by the buyer 71, but usually during this step the buyer 71 will not fill in this item). Each required material list 51 usually has more than one ordered product.

Step 202

The price enquiry list generating means 22 is for establishing a price enquiry list 52. The price enquiry list generating means 22 generates the price enquiry list 52 via the required material list 51, the serial number index database 37, and the supplier database 38, and stores the price enquiry list 52 in the price enquiring list database 32. the price enquiry list 52 includes at least a portion of the information stored in the required material list database 31, a portion of the information stored in the supplier database 38 and a portion of the information stored in the serial number index database 37.

Please refer to FIG. 8. FIG. 8 shows an embodiment of the supplier database 38 of the present invention. The supplier database 38 contains: a serial number from the supplier 381, an article name and specification 382, a sales price 383, a minimal order quantity 384, order preparation time 385, changing deliver date preparation time 386, and canceled order preparation time 387. The supplier database 38 is built up or maintained by the supplier 72 by way of a maintaining means 29.

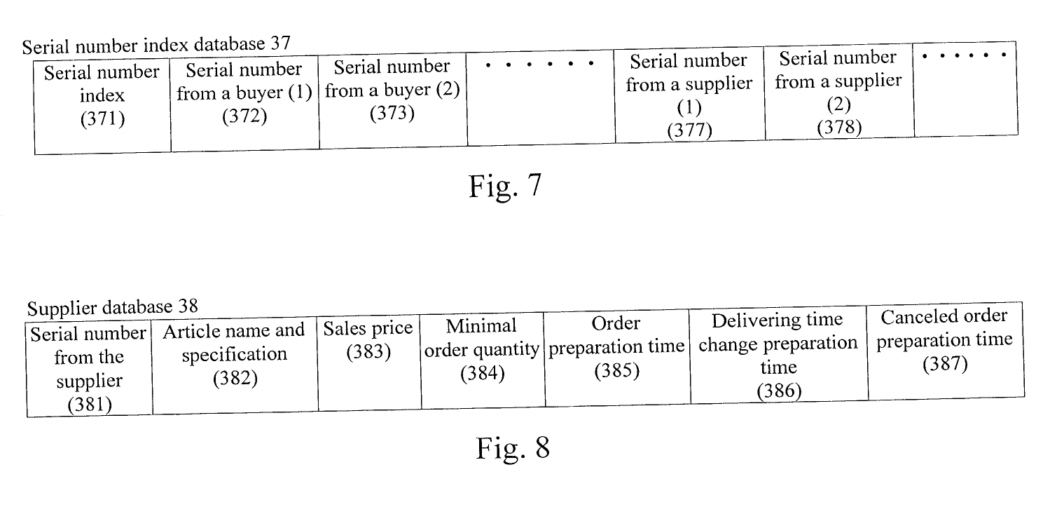

Please refer to FIG. 7. FIG. 7 shows an embodiment of the serial number index database 37 of the present invention. The serial number index database 37 includes a serial number index 371 for the different buyers 71, such as a serial number 372 from a buyer (1), a serial number 373 from a buyer (2), and the different suppliers 72, such as a serial number 374 from a supplier (1), a serial number 375 from a supplier (2), etc. Since every buyer and every supplier all have different serial numbers for an identical product, the business processing platform 10 needs to establish the serial number index 371 to establish corresponding relationships between the serial numbers from the suppliers and the serial numbers from the buyers. Therefore, the price enquiry list generating means 22 can match a serial number provided by a buyer with a serial number provided by a supplier via the serial number index database 37.

Please refer to FIG. 4. FIG. 4 shows an embodiment of the price enquiring list database 32 of the present invention. The price enquiring list database 32 contains: a serial number 323 from the buyer, an article name and specification 324, a quantity 325, and a desired price 326 from the required material list database 31. The price enquiring list database 32 also contains: a serial number 3291 from the supplier, a sales price 3293, a minimal order quantity 3294, an order preparation time 3295, a delivering time change preparation time 3296, and a canceled order preparation time 3297 from the supplier database 38, and a serial number index 322 from the serial number index 37.

The purchasing agent 321 is assigned to take charge of the required material list 51 (there may be a plurality of purchasing agents). The manner of assigning the purchasing agent may involve many different methods, such as being assigned by a supervisor, or being automatically assigned by utilizing a proper human resources managing software program.

A plurality of blank columns for a quotation price 327 can be inputted by the purchasing agent 321, or set up for a profit margi 328 (a 3% profit, for example). The quotation price will then be the sales price 3293 with the added profit margin.

Step 203

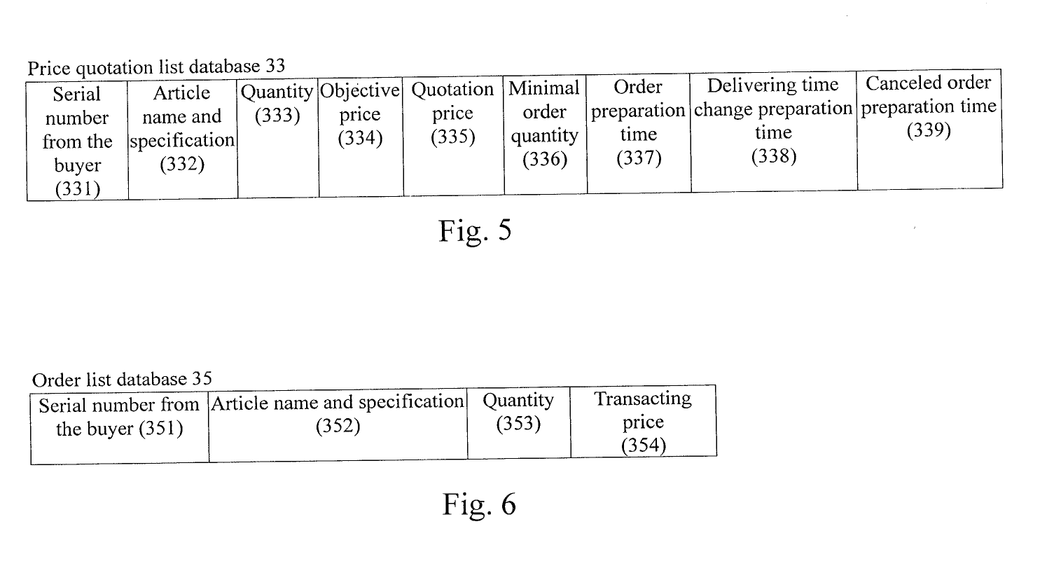

The price quotation list generating means 23 processes the price enquiry list 52 to generate a price quotation list 53 and stores the price quotation list 53 in the price quotation list database 33. The price quotation list 53 removes unnecessary information for the buyer 71 from the price enquiry list 52, such as: the purchasing agent 321, the serial number 322 of the buyer, the profit percentage 328, the serial number 3291 of the supplier, and the sales price. Please refer to FIG. 5. FIG. 5 shows an embodiment of the price quotation list database 33 of the present invention. The price quotation list 53 contains the serial number 331 from the buyer, an article name and specification 332, a quantity 333, a desired price 334, a price quotation 335, an order quantity 336, an order preparation time 337, a delivering time change preparation time 338, and a canceled order preparation time 339.

Step 204

The buyer 71 utilizes the order list generating means 25 to process the price quotation list 53 to generate an order list 55.

Please refer to FIG. 6. FIG. 6 shows an embodiment of the order list database 35 of the present invention. The order list database 35 contains a serial number 351 from the buyer, an article name and specification 352, a quantity 353 and a transacting price 354.

Step 205

If the buyer 71 is not satisfied with the price quotation list 53 or wants to modify the price quotation list 53, the buyer 71 can utilize a modifying means 24 to correct the price quotation list 53 as many times as needed.

Step 206

An order list distributing means 26 generates at least one shopping list 56 for each supplier 72 and each purchasing agent 321 based on the order list 55. For example, if the order list 55 includes 100 ordered products offered by three different suppliers 72 and purchased by 5 different purchasing agents 321, the order list distributing means 26 will generate 15 shopping lists 56 (3×5=15). The shopping list 56 includes a plurality of blank columns, such as the serial number 351 from the buyer, the article name and specification 352, the quantity 353 from the order list 55, and the serial number index 322, the serial number 323 from the buyer and the sales price 3293 from the price enquiry list 52.

In addition, the supplier 72 can first confirm the price enquiry list 52 without the quotation price 327 and the profit percentage 328. Furthermore, since the price quotation list is generated by deleting some information in the price enquiry list, the price quotation list database is not necessary. The structure of the said databases can be represented in many other different ways.

Although the present invention has been explained in relation to its preferred embodiment, it is to be understood that many other possible modifications and variations can be made without departing from the spirit and scope of the invention as hereinafter claimed.

What is claimed is:

1. A business information processing platform for transforming a procurement of a buyer into an order to a supplier, the business information processing platform comprising:
(A) a storage device comprising:
a required material list database for storing related information about merchandise ordered by the buyer, the database containing: a serial number from the buyer, an article name and specification, and a quantity;
a supplier database for storing related information about merchandise provided by the supplier, the database containing: a serial number from the supplier, an article name and specification, and a sales price;
a serial number index database for storing indexes for the business processing platform to link the supplier database to the required material list database, the serial number index database containing a serial number index, a serial number provided by the supplier and a serial number provided by the buyer;
a price enquiring list database containing at least a portion of the information stored in the required material list database, at least a portion of the information stored in the supplier database, and a serial number index;
an order list database for storing related information about confirmed ordered merchandise from the buyer, the order list database containing a serial number from the buyer, an article name and specification, a quantity and a transacting price;
(B) a memory comprising a plurality of executable software programs; and
(C) a processor for executing the software programs stored in the memory to process the following means:
a material list establishing means for establishing a list of material for the buyer and storing the list of material required material list in the required material listrequired material list database;
a price enquiry list generating means for matching a serial number provided by the buyer with a serial number provided by the supplier and combining at least a portion of information stored in the required material listrequired material list database with a portion of the information stored in the supplier database via the serial number index database to establish a price enquiry list and to store the price enquiry list in the price enquiring list database;
a price quotation list generating means for processing the price enquiry list to generate a price quotation list, the price quotation list containing the serial number from the buyer, an article name and specification, a quantity and a price quotation; and
an order list generating means for processing the price quotation list to generate an order list.

2. The business information processing platform of claim 1, wherein the price enquiry list generating means generates a plurality of blank columns for assigning a purchasing agent.

3. The business information processing platform of claim 1, wherein the supplier database further contains at least one of the following pieces of information: a minimal order quantity, an order preparation time, a delivering time change preparation time or a canceled order preparation time.

4. The business information processing platform of claim 3, wherein the price quotation list further contains at least one of the following pieces of information: a minimal order quantity, an order preparation time, a delivering time change preparation time, or a canceled order preparation time.

5. The business information processing platform of claim 1, wherein the storage device further contains a price quotation list database to store the price quotation lists.

6. The business information processing platform of claim 1, wherein the serial number provided by the buyer stored in the serial number index database comprises a plurality of serial numbers from different buyers.

7. The business information processing platform of claim 1, wherein the serial number provided by the supplier stored in the serial number index database comprises a plurality of serial numbers provided by different suppliers.

8. A method of processing purchase information applied to a business information processing platform for transforming a procurement of a buyer into an order to a supplier, the method comprising:
receiving a required material list from the buyer for storage in a storage device of the business information processing platform, the required material list containing related information about merchandise ordered by the buyer;
establishing and storing a price enquiring list in the storage device of the business information processing platform, the price enquiring list containing related information about merchandise ordered by the buyer and related information about merchandise provided by the supplier, which includes a sales price provided by the supplier and a price quotation provided by the business information processing platform to the buyer;
establishing a price quotation list, the price quotation list containing related information about requested merchandise and the price quotation provided by the business information processing platform to the buyer; and
generating an order list after the buyer confirms the price quotation list to the business information processing platform, wherein the order list contains related information about confirmed merchandise.

9. The method of claim 8, wherein when establishing the price enquiring list, the related information about the merchandise provided by the supplier contains at least one of the following: a minimal order quantity, an order preparation time, delivering time change preparation time, or a canceled order preparation time.

10. The method of claim 8, wherein the related information about the merchandise provided by the supplier is stored in a storage device of the business information processing platform.
